(19) United States
(12) Patent Application Publication
(10) Pub. No.: US 2015/0101623 A1
(43) Pub. Date: Apr. 16, 2015

(54) ELECTRONIC CIGARETTE AND METHOD FOR ELECTRONIC CIGARETTE EXTINGUISHMENT

(71) Applicant: Qiuming Liu, Shenzhen (CN)

(72) Inventor: Qiuming Liu, Shenzhen (CN)

(21) Appl. No.: 14/504,213

(22) Filed: Oct. 1, 2014

Related U.S. Application Data
(63) Continuation of application No. PCT/CN2013/085319, filed on Oct. 16, 2013.

(51) Int. Cl. A24F 47/00; H05B 1/02

(52) U.S. Cl. CPC A24F 47/008; H05B 1/0244
USPC 131/328; 131/329

(57) ABSTRACT

The present application relates to an electronic cigarette and a method for the electronic cigarette extinguishment, wherein the electronic cigarette comprises an atomizer assembly and a battery assembly, the battery assembly includes a sleeve tube, a controller deposited in the sleeve tube, a smoking switch electrically connected to the controller and a push-button switch; the push-button is deposited at one end of the sleeve tube that is far away from the mouth end; when the push-button switch is pressed down, the controller is triggered to control the electronic cigarette to switch to a prohibiting working state from a normal working state.

### CROSS-REFERENCE TO RELATED APPLICATION

This application is a continuation application of International Patent Application No. PCT/CN2013/085319, by Qiuming LIU, filed Oct. 16, 2013, which is hereby incorporated herein in its entirety by reference.

### TECHNICAL FIELD

The present application relates to the technical field of daily electronic products, and more particularly, relates to an electronic cigarette and a method for the electronic cigarette extinguishment.

### BACKGROUND

Severed as substitute of cigarettes, electronic cigarettes mainly consist of atomizer assemblies and battery assemblies; and for some of the electronic cigarettes, one end of each battery assembly has a cigarette ash light arranged on it, and the cigarette ash light is configured to simulate the burning of tobacco when the electronic cigarettes are in working states.

For an electronic cigarette without a cigarette ash light, when a pneumatic sensor has sensed smoking airflow, the controller inside the battery assembly controls the atomizer assembly to carry out the atomization. While smoking a real cigarette, it is common for user to press the cigarette end habitually to extinguish cigarette; besides, after the extinguishment, even though the user have the actions of inhalation, the cigarette will not generate smoke. According to the electronic cigarette in the prior art, generally, when the user carry out the action of smoking, which makes the pneumatic sensor sense the smoking airflow, the controller controls the atomization to be carried out immediately, and there is no control for extinguishment. And for an electronic cigarette provided with a cigarette ash light, in general, the cigarette ash light may light up only after a pneumatic sensor has sensed the air flow, it has no cigarette extinguishment, and the user experience is poor.

Though a switch is arranged on a sleeve tube of an electronic cigarette to directly control the initiate of the electronic cigarette in the prior art. However, since the switch is arranged on the sleeve tube in the prior art, on one hand, when user wants to extinguish the electronic cigarette, he needs to find the switch exclusively, and press the switch; but in reality, when smoking, user will press the cigarette end to extinguish the cigarette. Therefore, the arrangement of the switch of this type in the prior art causes the user experience to be reduced greatly. On the other hand, user may press the switch incidentally, which leads to incorrect manipulation.

Therefore, there are drawbacks in the prior art, and it needs to be improved.

### BRIEF SUMMARY

The objective of the present application is to provide an improved electronic cigarette and a method for the electronic cigarette extinguishment, aiming at the drawbacks that the user experience is poor and it is easily to lead to incorrect manipulation for the electronic cigarette extinguishment in the prior art.

In accordance with one aspect of the present application, an electronic cigarette is provided, comprises an atomizer assembly and a battery assembly, wherein the battery assembly includes a sleeve tube, a controller deposited in the sleeve tube, a smoking switch electrically connected to the controller and a push-button switch; the push-button switch is deposited at one end of the sleeve tube that is far away from the mouth end; when the push-button switch is pressed down, the controller is triggered to control the electronic cigarette to switch to a prohibiting working state from a normal working state.

In one embodiment, the electronic cigarette further includes a cigarette ash light which is deposited at the end of the sleeve tube that is far away from the mouth end, and the cigarette ash light is configured to simulate the burning of the tobacco; the cigarette ash light grows darker after the smoking switch is switched on, until the push-button switch controls the electronic cigarette to stop working, then the cigarette ash light is extinguished.

In this embodiment, the push-button switch includes a switch body electrically connected to the controller and an end cover deposited on the end face of the sleeve tube.

In this embodiment, a projection is formed on the inner wall of the end cover facing toward the switch body and extending along the axis direction of the sleeve tube; a second recess is formed on the projection along the axis direction of the sleeve tube, and the switch body is partially contained in the second recess;

when the switch body is in the opening state, the switch body and the bottom of the second recess are abutted against each other.

Yet in this embodiment, a connector is further provided on the end face of the sleeve tube; the connector includes a base body;

an annular projection which is formed on the end face of the base body that is facing toward the switch body is provided, and is extending along the axis direction of the sleeve tube; the annular projection is sleeved inside the sleeve tube, and the end portion of the sleeve tube is abutted against the end portion of the base body;

a through-hole adapted to the end cover is defined in the centre of the base body, and the end cover is inserted into the through-hole; when the switch body is in the opening state, the outer wall of the end cover and the outer wall of the base body form a smooth connection surface.

Yet in this embodiment, the electronic cigarette further includes a fixing base and a PCB board which are deposited in the axis direction of the sleeve tube; a through-hole that wires passes through is defined in the fixing base along the axis direction of the sleeve tube; a mounting recess is defined at one end of the fixing base closed to the end cover; the PCB board is mounted fixedly in the mounting recess, and the switch body is deposited on the PCB board.

In another embodiment, the push-button switch further includes a keyboard deposited between the end cover and the switch body; the hardness of the keyboard is larger than the hardness of the end cover, and the end cover is plugged in the sleeve tube.

In this embodiment, the keyboard is in the form of a disc, a spherical projection is formed on one side of the keyboard facing toward the end cover, and the spherical projection is adapted to the interior sidewall of the end of the end cover; a first recess is formed on one side of the keyboard away from the end cover, and the switch body is partially contained in the first recess;

when the switch body is in the opening state, the switch body and the bottom of the first recess are abutted against each other.

Preferably, the push-button switch is a pressure sensor.

Preferably, the smoking switch is a pneumatic sensor positioned in the airflow channel of the electronic cigarette.

In another aspect, a method for an electronic cigarette extinguishment is provided, wherein by pressing a push-button switch deposited at one end of a sleeve tube that is far away from a mouth end, a controller deposited inside the sleeve tube is triggered to control the electronic cigarette to switch to a prohibiting working state from a normal working state.

In one embodiment, the electronic cigarette entering the normal working state is achieved by pressing down the push-button switch, and a smoking switch is valid only when the electronic cigarette has entered the normal working state.

In this embodiment, during the process that the smoking switch is triggered, a cigarette ash light is lighted; the cigarette ash light is deposited at the end of the sleeve tube that is far away from the mouth end and is configured for the simulation of the burning of the tobacco.

In another embodiment, the electronic cigarette entering the normal working state is achieved by triggering a smoking switch; after the smoking switch has been triggered, a cigarette ash light deposited at the end of the sleeve tube that is far away from the mouth end and is configured for the simulation of the burning of the tobacco grows darker until reaching to the end of a predetermine period of time after the smoking switch is triggered or pressing down the push-button switch to control the electronic cigarette to stop working, and then the cigarette ash light is extinguished.

When implementing the electronic cigarette and the method for the electronic cigarette extinguishment of the present application, the following advantageous can be achieved: according to the electronic cigarette of the present application, a push-button switch is provided at the end of the sleeve tube that is away from the mouth end; and when the push-button switch is pushed down, the controller is triggered to control the electronic cigarette switch to the prohibiting working state from the normal working state. Therefore, the electronic cigarette according to the present application can simulate the action of extinguishment by pressing down the end. The method for the extinguishment conforms to the habit of the smoker when extinguishing the cigarette, improving the user experience of extinguishing cigarette greatly; besides, it is helpful for the smoker to stop smoking, the operation is easy, and is not easy to occur the incorrect manipulation.

### BRIEF DESCRIPTION OF THE DRAWINGS

The present application will be further described with reference to the accompanying drawings and embodiments in the following, in the accompanying drawings:

FIGS. 1A and 1B illustrate two block diagrams to show the working principle of an electronic cigarette according to the present application;

FIG. 2A illustrates a circuit diagram of an method for the electronic cigarette extinguishment according to a first embodiment of the present application;

FIG. 2B illustrates a circuit diagram of an method for the electronic cigarette extinguishment according to a second embodiment of the present application;

FIG. 3 illustrates a schematic view of a battery assembly of the electronic cigarette according to the first embodiment of the present application;

FIGS. 4A and 4B illustrate a partially exploded view of the battery assembly of the electronic cigarette according to the first embodiment of the present application;

FIG. 5 illustrates a schematic view of a battery assembly of the electronic cigarette according to the second embodiment of the present application; and

FIGS. 6A and 6B illustrate a partially exploded view of the battery assembly of the electronic cigarette according to the second embodiment of the present application.

### DETAILED DESCRIPTION OF THE PREFERRED EMBODIMENT

In order to make the technical features, the propose and the technical effect of the present application more clearly, the present application will now be described in detail with reference to the accompanying drawings and embodiments.

The present application provides an electronic cigarette and an method for the electronic cigarette extinguishment, aiming at the drawbacks that the user experience is poor and it is easily to lead to incorrect manipulation for the electronic cigarette extinguishment in the prior art.

According to the present application, the electronic cigarette is provided with a push-button switch at one end of a sleeve tube that is away from a mouth end. When the push-button switch is pressed down, the controller is triggered to control the electronic cigarette to switch to a prohibiting working state from a normal working state. Therefore, the electronic cigarette according to the present application can simulate the action of extinguishing the electronic cigarette by pressing the end portion. The extinguishment of this type not only improves the user experience, but also avoids the defect of incorrect manipulation when arranging the switch on the sleeve tube in the prior art.

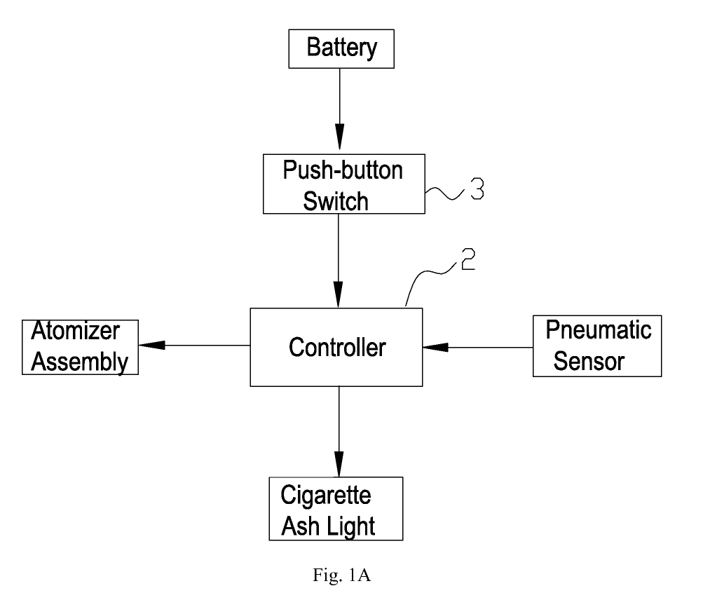

FIG. 1A and FIG. 1B illustrate two block diagrams to show the working principle of an electronic cigarette according to the present application.

The electronic cigarette comprises a controller 2; and a pneumatic sensor, a battery, a cigarette ash light and an atomizer assembly which are all electrically connected to the controller 2 respectively. The pneumatic sensor is deposited inside the airflow channel of the electronic cigarette and serves as a smoking switch of the electronic cigarette. In the present application, additionally, it is provided with a push-button switch 3; and by pressing the end portion of the push-button switch 3, the electronic cigarette is triggered to exit a normal working state. There are two ways of triggering. One is that the push-button switch 3 is designed directly as a main switch for the connections between all the components and the battery. As shown in FIG. 1A, the push-button switch 3 is connected to the battery and the controller 2 respectively, and thus by switching off the push-button switch 3, the power supplied to all the components are cut off. Another is that the push-button switch 3 is designed as a sensing element which can generate electric signals corresponding to the deformation caused by the pressure, or a switch which can directly change the composition of circuit so as to provide trigger electric signals. As shown in FIG. 1B, the push-button switch 3 is directly connected to the controller 2, and the controller 2 is triggered to control the electronic cigarette to exit the normal working state.

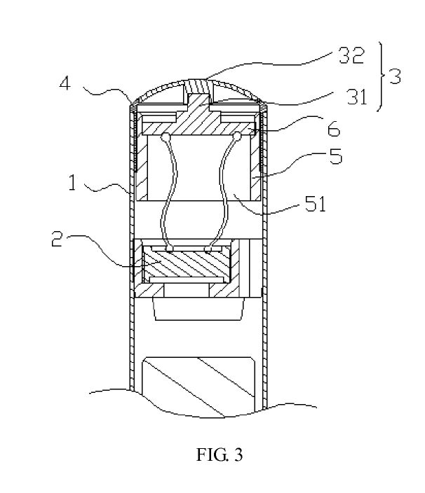

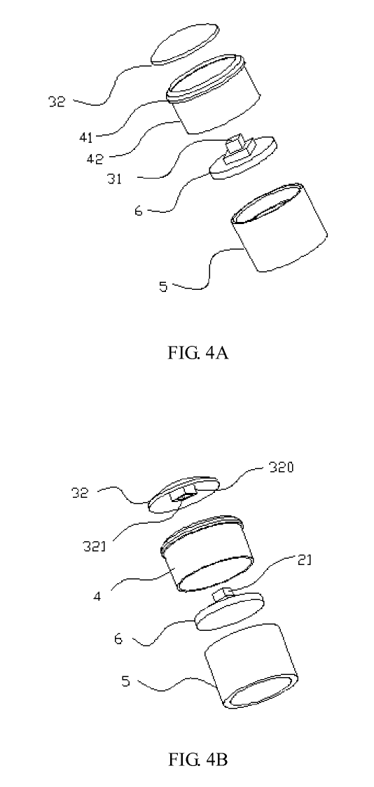

FIG. 3 illustrates a schematic view of a battery assembly of the electronic cigarette according to the first embodiment of the present application; and FIGS. 4A and 4B illustrate a partially exploded view of the battery assembly of the electronic cigarette according to the first embodiment of the present application.

The electronic cigarette comprises an atomizer assembly and a battery assembly. The battery assembly includes a sleeve tube 1, a controller 2 deposited inside the sleeve tube 1 and a push-button switch 3 which is electrically connected to the controller 2 and is deposited at the end of the sleeve tube 1 that is away from the mouth end. When the push-button switch 3 is pressed down, the controller 2 is triggered to control the electronic cigarette to switch to a prohibiting working state from a normal working state.

The electronic cigarette further includes a cigarette ash light which is deposited at the end of the sleeve tube 1 that is away from the mouth end, and the cigarette ash light is configured to simulate the burning of the tobacco. For the electronic cigarette provided with the cigarette ash light, in order to simulate the extinguishment of the real cigarette, the cigarette ash light is controlled to remain lighting within a predetermined period of time after smoking, and the cigarette ash light grows darker; at this time, the normal working state refers to the state that the cigarette ash light is lighted, and the prohibiting working state refers to the state after the cigarette ash light is extinguished. Within the predetermined period of time after the smoking switch is switched on, the cigarette ash light grows darker until the push-button switch 3 controls the electronic cigarette to stop working, and the cigarette ash light is then extinguished. If the push-button switch 3 has not been pressed down within the predetermined period of time, the controller 2 may control the cigarette ash light to be extinguished automatically, so as to avoid the waste of electric power caused by forgetting to control the cigarette ash light to be extinguished.

For the electronic cigarette without a cigarette ash light or the electronic cigarette with a cigarette ash light which is lighted only when that the pneumatic sensor has sensed the flow, the normal working state refers to a state that the smoking switch is valid, and the prohibiting working state refers to a state that the smoking switch is invalid, that is, the smoking switch no longer controls smoking normally. For example, in the prohibiting working state, the pneumatic sensor senses airflow signal when user inhales, however, the controller 2 no more controls the atomization of the atomizer assembly and the lighting of the cigarette ash light.

The push-button switch 3 may be any one of a pressure sensor and a key switch.

In the first embodiment, the push-button switch 3 includes a switch body 31 and an end cover 32 deposited on the end face of the sleeve tube 1. The end cover 32 is made from transparent material, and a projection 320 is formed on the inner wall of the end cover 32 facing toward the switch body 31 and is extending along the axis direction of the sleeve tube 1. A second recess 321 is formed on the projection 320 along the axis direction of the sleeve tube 1, and the switch body 31 is partially contained in the second recess 321. When the switch body 31 is in the opening state, the switch body 31 and the bottom of the second recess 321 are abutted against each other. Thereby, the force applied onto the end cover 32 can be passed to the switch body 31 by pushing down the end cover 32 slightly.

For the electronic cigarette that the switch body 31 is directly contacted to the end cover 32, a connector 4 is further provided on the end face of the sleeve tube 1. When assembling the electronic cigarette, the switch body 31 and the end cover 32 are firstly assembled together, and the assembly is convenient. The connector 4 includes a base body 41 and an annular projection 42 which is formed on the end face of the base body 41 that is facing toward the switch body 31, and is extending along the axis direction of the sleeve tube 1. The annular projection 42 is sleeved inside the sleeve tube 1, and the end portion of the sleeve tube 1 is abutted against the end portion of the base body 41. A through-hole adapted to the end cover 32 is defined in the centre of the base body 41, and the end cover 32 is inserted into the through-hole. Besides, when the switch body 31 is in the opening state, the outer wall of the end cover 32 and the outer wall of the base body 41 form a smooth connection surface, which is not only beautiful but also convenient for user to press down so as to apply the force.

The electronic cigarette further includes a fixing base 5 and a PCB board 6 which are deposited in the axis direction of the sleeve tube 1. A through-hole 51 for wires passing through is defined in the fixing base 5 along the axis direction of the sleeve tube 1. A mounting recess is defined at one end of the fixing base 5 closed to the end cover 32. The PCB board 6 is mounted fixedly in the mounting recess, and the switch body 31 is deposited on the PCB board 6. A cigarette ash light is deposited on one side of the PCB board 6 facing toward the end cover 32. When in a normal working state, the cigarette ash light emits light, and the light passes through the end cover 32.

The working principle of the present embodiment is shown in FIG. 1B, when the end cover 32 is pressed down, the switch body 31 is forced to change the working state, sending trigger signal to the controller 2, and the electronic cigarette is controlled to enter the prohibiting working state.

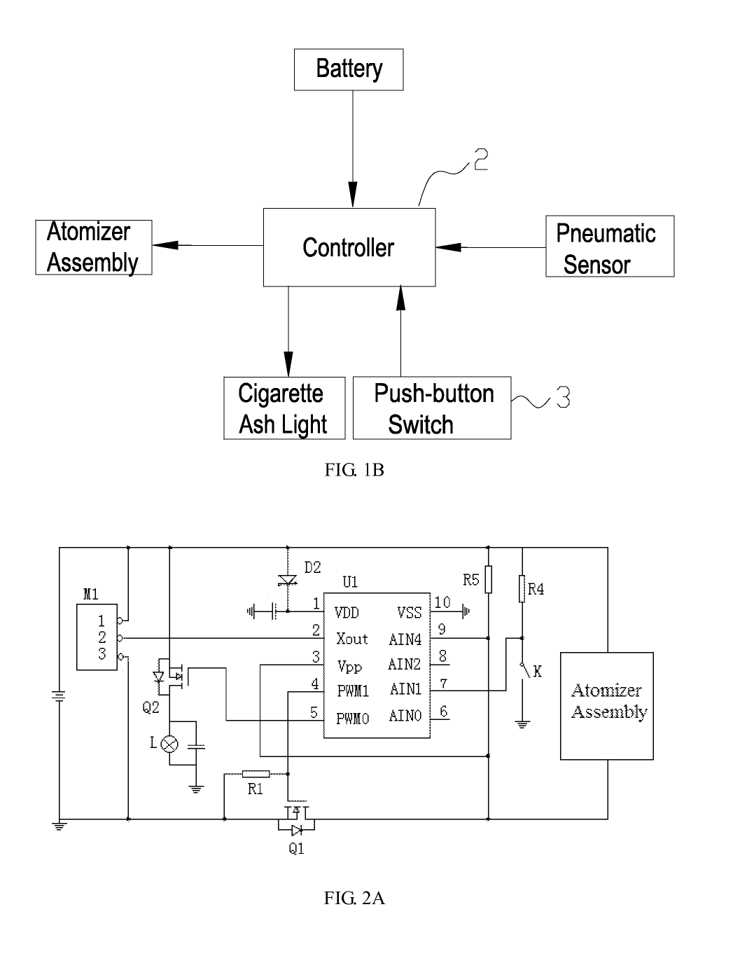

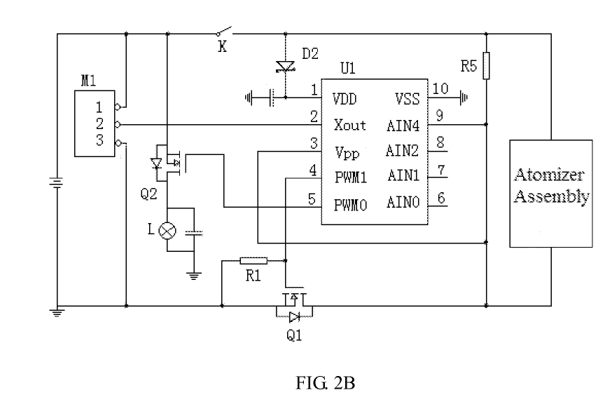

Specifically, as shown in FIG. 2A, in this embodiment, the switch body 31 is a key switch K. The controller 2 includes a microprocessor U1 with the type of SN8P2711. The key switch 3 is connected to the seventh pin of the microprocessor U1, the pneumatic sensor M1 is connected to the second pin of the microprocessor U1, and the cigarette ash light L is connected to the fifth pin of the microprocessor U1 through a MOS transistor Q2. The key switch K mainly controls the level signal transmitted to the microprocessor U1, and the change of the level signal directly controls whether the seventh pin of the microprocessor U1 is grounded by the key switch K. When the second pin of the microprocessor U1 receives a trigger signal from the pneumatic sensor M1, the fifth pin of the microprocessor U1 outputs a PWM signal with decreasing duty radio, and the cigarette ash light L grows darker. Within the predetermine period of time, if the end cover 32 is pressed down, the key switch K is switched on, and the seventh pin of the microprocessor U1 is grounded; the fifth pin of the microprocessor U1 therefore outputs low level signal, the MOS transistor Q2 is cut off, and the cigarette ash light L is extinguished. If the end cover 32 has not been pressed down during this time, then when the predetermine period of time runs out, the fifth pin of the microprocessor U1 outputs low level signal, the MOS transistor Q2 is cut off, and the cigarette ash light L is extinguished. The specific circuit is integrated on the PCB board 6.

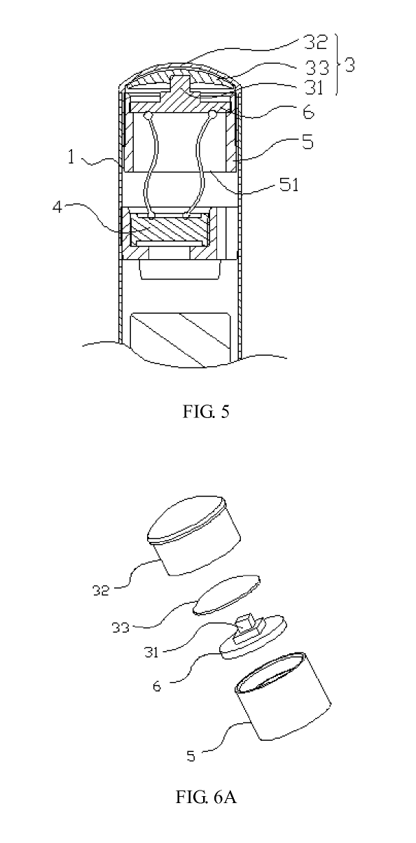

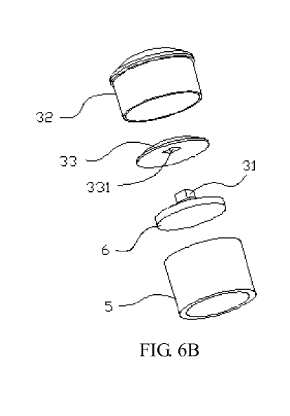

FIG. 5 illustrates a schematic view of a battery assembly of the electronic cigarette according to the second embodiment of the present application; and FIGS. 6A and 6B illustrate a partially exploded view of the battery assembly of the electronic cigarette according to the second embodiment of the present application.

In the second embodiment, the push-button switch 3 includes a switch body 31 connected to the controller 2, and an end cover 32 deposited on the end face of the sleeve tube 1, and further includes a keyboard 33 deposited between the end cover 32 and the switch body 31. The hardness of the keyboard 33 is larger than the hardness of the end cover 32, and the end cover 32 is plugged in the sleeve tube 1.

The keyboard 33 is in the form of a disc, a spherical projection is formed on one side of the keyboard 33 facing toward the end cover 32, and the spherical projection is adapted to the interior sidewall of the end of the end cover 32. A first recess 331 is formed on one side of the keyboard 33 away from the end cover 32, and the switch body 31 is partially contained in the first recess 331. When the switch body 31 is in the opening state, the switch body 31 and the bottom of the first recess 331 are abutted against each other.

A reservation space is saved between the circumferential side edge of the keyboard 33 and the circumferential interior sidewall of the end cover 32. If the keyboard 33 is made from hard material, there should be a certain reservation space remained for the convenience of the keyboard 33 moving along the axis direction of the sleeve tube 1. If the keyboard 33 is made from soft material, when pressed down, the keyboard 33 can extend toward the reservation space, and thus the stress bounced in the axis direction is reduced.

In the second embodiment, the end cover 32 includes a cover body and a connection portion. The connection portion is equivalent to the connector 4 in the first embodiment. Since the keyboard 33 can be firstly assembled with the switch body 31 during the assembly in this embodiment, there is no need to design a separated connector.

To sum up, according to the electronic cigarette of the present application, a push-button switch is provided at the end of the sleeve tube that is away from the mouth end, when the push-button switch is pushed down, the controller is triggered to control the electronic cigarette switch to the prohibiting working state from the normal working state. Therefore, the electronic cigarette according to the present application can simulate the action of extinguishment by pressing down the end. The action of extinguishment conforms to the habitual behavior that the user extinguishes the real cigarette; the user experience is improved greatly, and the possibility of incorrect manipulation is reduced.

The present application further provides a method for an electronic cigarette extinguishment. By pressing a push-button switch 3 deposited at the end of a sleeve tube 1 that is far away from a mouth end, a controller 2 deposited inside the sleeve tube 1 is triggered to control the electronic cigarette to switch to a prohibiting working state from a normal working state.

Specifically, in the first embodiment, when the electronic cigarette is in the normal working state, a smoking switch is valid; and when the electronic cigarette is in the prohibiting working state, the smoking switch is invalid. In this embodiment, the smoking switch is a pneumatic sensor arranged inside the airflow channel of the electronic cigarette. The method mainly includes the following steps:

S1, pressing the push-button switch 3, the electronic cigarette entering the normal working state, and the smoking switch is valid;

S2, triggering the smoking switch anytime, and implementing the smoking action;

S3, pressing down the push-button switch 3, the electronic cigarette entering the prohibiting working state, the smoking switch is invalid; even triggering the smoking switch, the electronic cigarette no more implementing the corresponding atomization action and/or lighting.

For the electronic cigarette without a cigarette ash light or the electronic cigarette with a cigarette ash light which is lighted only in the process that the pneumatic sensor senses the flow, the normal working state refers to a state that the smoking switch is valid, and the prohibiting working state refers to a state that the smoking switch is invalid, that is, the smoking switch no longer controls smoking normally. The smoking action includes the atomization of the atomizer assembly and the lighting of the cigarette ash light.

The working principle is as shown in FIG. 1A, when an end cover 32 of the push-button switch 3 is pressed down, an switch body 31 of the push-button switch 3 is forced to change the working state, cutting of the electrical connection between the battery and the controller 2, and the electronic cigarette is consequently controlled to enter the prohibiting working state.

Specifically, as shown in FIG. 2B, in this embodiment, the controller 2 includes a microprocessor U1 with the type of SN8P2711. The key switch K is connected to the microprocessor U1 and the battery respectively, the pneumatic sensor M1 is connected to the second pin of the microprocessor U1, the cigarette ash light L is connected to the battery through a MOS transistor Q2, and the grid of the MOS transistor Q2 is connected to the fifth pin of the microprocessor U1 . The atomizer assembly is connected to the battery through a MOS transistor Q1, and the grid of the MOS transistor Q1 is connected to the fourth pin of the microprocessor U1. The key switch K mainly controls the power supplied to the power source pin of the microprocessor U1. If the end cover 32 is pressed down, the key switch K may be switched on, all the components may work normally, and the pneumatic sensor M1 is valid. During the process of the pneumatic sensor M1 sensing the airflow, that is, during the inhalation, the fourth pin and the fifth pin of the microprocessor U1 both output high level signal; the MOS transistors Q1 and Q2 are conducted, the cigarette ash light L is lighted, and the atomizer assembly implements the atomization. After inhalation, the fourth pin and the fifth pin of the microprocessor U1 both output low level signal; the MOS transistors Q1 and Q2 are cut off, the cigarette ash light L is extinguished, and the atomizer assembly stops the atomization. When inhalation happens again, the process may be repeated. If the end cover 32 is pressed down again, which makes the key switch K open, all the components stops working, and the pneumatic sensor Ml is invalid; at this time, even the pneumatic sensor has sensed the airflow signal, the cigarette ash light L is no more lighted, and the atomizer assembly no more implements the atomization action.

The second embodiment only aims at the electronic cigarette provided with a cigarette ash light, the cigarette ash light still remains lighting within a predetermine period of time after pneumatic sensors has sensed the airflow, and the cigarette ash light grows darker. When the electronic cigarette is in a stopping working state in the second embodiment, a smoking switch is still valid; however, after the smoking switch is triggered each time, the cigarette ash light keeps in the lighting state. A prohibiting working state here refers to the extinguishing state of the cigarette ash light. The method in the second embodiment mainly includes the following steps:

S1, triggering the smoking switch, the electronic cigarette entering the normal working state, and the cigarette ash light configured for the simulation of burning of the tobacco and deposited at the end of the sleeve tube that is away from the mouth end lighting up;

S2, starting time-keeping, the cigarette ash light growing darker, if the smoking switch is triggered again within the predetermine period of time, keeping time again; if the push-button switch 3 is pressed down, then the controller 2 controlling the electronic cigarette entering the prohibiting working state, and the cigarette ash light is extinguished;

S3, when the time reaching to the end of the predetermine time, controlling the electronic cigarette entering the prohibiting working state, and the cigarette ash light is extinguished.

At this time, the normal working state refers to the lighting of the cigarette ash light, and the prohibiting working state refers to the extinguishing of the cigarette ash light. Within the predetermine period of time after the smoking switch is switched on, the cigarette ash light grows darker, until the push-button switch 3 controls the electronic cigarette to stop working, and then the cigarette ash light is extinguished; if the push-button switch 3 has not been pressed down within the predetermined period of time, then the controller 2 controls the cigarette ash light to be extinguished automatically; preferably, the predetermine period of time is sixty seconds, so as to simulate the extinguishment of the real cigarette.

The working principle according to this embodiment is as shown in FIG. 1B, when the end cover 32 is pressed down, the switch body 31 is forced to change the working state, the controller 2 receives trigger signal, and the electronic cigarette is controlled to enter the prohibiting working state.

Specifically, as shown in FIG. 2A, in this embodiment, the controller 2 includes a microprocessor U1 with the type of SN8P2711. The key switch K is separately connected to the ground signal and the seventh pin of the microprocessor U1, the pneumatic sensor M1 is connected to the second pin of the microprocessor U1, the cigarette ash light L is connected to the battery through a MOS transistor Q2, and the grid of the MOS transistor Q2 is connected to the fifth pin of the microprocessor U1. The key switch K mainly controls the level signal transmitted to the microprocessor U1, and the change of the level signal directly controls whether the seventh pin of the microprocessor U1 is grounded by the key switch K. When the second pin receives a trigger signal from the pneumatic sensor M1, the fifth pin outputs a PWM signal with decreasing duty radio, and the cigarette ash light L grows darker. Within the predetermine period of time, if the end cover 32 is pressed down and makes the key switch K switched on, and the seventh pin is grounded, the fifth pin of the microprocessor U1 thereby outputs low level signal, the MOS transistor Q2 is cut off, and the cigarette ash light L is extinguished. If the end cover 32 has not been pressed down, then when the predetermine period of time runs out, the fifth pin of the microprocessor U1 outputs low level signal, the MOS transistor Q2 is cut off, and the cigarette ash light L is extinguished.

To sum up, the method for extinguishment according to the present application can simulate the extinguishment of the cigarette veritably. For the electronic cigarette without cigarette ash light, the whole electronic cigarette is stopped working by pressing down the end away from the suction nozzle end. And for the electronic cigarette provided with cigarette ash light, within the predetermine period of time, the same result can be achieve by using the same method, as well as by making cigarette ash light remain lighting within the prolonged predetermine period of time after smoking, and thus within the predetermine period of time, the cigarette ash light can be directly extinguished only by pressing down the end away from the suction nozzle end, therefore, it can simulate the extinguishment of real cigarette. The method for the extinguishment conforms to the habit of the smoker when extinguishing the cigarette, improving the user experience of extinguishing cigarette greatly; besides, it is helpful for the smoker to stop smoking, the operation is easy, and is not easy to occur the incorrect manipulation.

Although the present application is illustrated with the embodiments accompanying the drawings, the present application is not limited to the above-mentioned specific embodiments, and the above-mentioned embodiments are only for illustration, not for limitation. In the inspiration of the present application, those skilled in the art may make many modifications, without going beyond the purpose and the scope the claims intend to protect of the present application; for example, the smoking switch may be a manual mechanical switch. All these belong to the protection of the present application.

What is claimed is:

1. An electronic cigarette, comprising an atomizer assembly and a battery assembly, wherein the battery assembly includes a sleeve tube, a controller deposited in the sleeve tube, a smoking switch electrically connected to the controller and a push-button switch; the push-button switch is deposited at one end of the sleeve tube that is far away from a mouth end; when the push-button switch is pressed down, the controller is triggered to control the electronic cigarette to switch to a prohibiting working state from a normal working state.

2. The electronic cigarette according to claim 1, wherein the electronic cigarette further includes a cigarette ash light which is deposited at the end of the sleeve tube that is far away from the mouth end, and the cigarette ash light is configured to simulate the burning of the tobacco; the cigarette ash light grows darker after the smoking switch is switched on, until the push-button switch controls the electronic cigarette to stop working, then the cigarette ash light is extinguished.

3. The electronic cigarette according to claim 1, wherein the push-button switch includes a switch body electrically connected to the controller and an end cover deposited on the end face of the sleeve tube.

4. The electronic cigarette according to claim 3, wherein the push-button switch further includes a keyboard deposited between the end cover and the switch body; the hardness of the keyboard is larger than the hardness of the end cover, and the end cover is plugged in the sleeve tube.

5. The electronic cigarette according to claim 4, wherein the keyboard is in the form of a disc, a spherical projection is formed on one side of the keyboard facing toward the end cover, and the spherical projection is adapted to the interior sidewall of the end of the end cover; a first recess is formed on one side of the keyboard that is away from the end cover, and the switch body is partially contained in the first recess;
when the switch body is in the opening state, the switch body and the bottom of the first recess are abutted against each other.

6. The electronic cigarette according to claim 3, wherein a projection is formed on the inner wall of the end cover facing toward the switch body and extending along the axis direction of the sleeve tube; a second recess is formed on the projection along the axis direction of the sleeve tube, and the switch body is partially contained in the second recess;
when the switch body is in the opening state, the switch body and the bottom of the second recess are abutted against each other.

7. The electronic cigarette according to claim 6, wherein a connector is further provided on the end face of the sleeve tube; the connector includes a base body;
an annular projection which is formed on the end face of the base body that is facing toward the switch body is provided, and is extending along the axis direction of the sleeve tube; the annular projection is sleeved inside the sleeve tube, and the end portion of the sleeve tube is abutted against the end portion of the base body;
a through-hole adapted to the end cover is defined in the centre of the base body, and the end cover is inserted into the through-hole; when the switch body is in the opening state, the outer wall of the end cover and the outer wall of the base body form a smooth connection surface.

8. The electronic cigarette according to claim 1, wherein the push-button switch is a pressure sensor.

9. The electronic cigarette according to claim 3, wherein the electronic cigarette further includes a fixing base and a PCB board which are deposited in the axis direction of the sleeve tube; a mounting recess is defined at one end of the fixing base closed to the end cover; the PCB board is mounted fixedly in the mounting recess, and the switch body is deposited on the PCB board.

10. The electronic cigarette according to claim 1, wherein the smoking switch is a pneumatic sensor positioned in the airflow channel of the electronic cigarette.

11. A method for an electronic cigarette extinguishment, wherein by pressing a push-button switch deposited at one end of a sleeve tube that is far away from a mouth end, a controller deposited inside the sleeve tube is triggered to control the electronic cigarette to switch to a prohibiting working state from a normal working state.

12. The method for the electronic cigarette extinguishment according to claim 11, wherein the electronic cigarette entering the normal working state is achieved by pressing down the push-button switch, and a smoking switch is valid only when the electronic cigarette has entered the normal working state.

13. The method for the electronic cigarette extinguishment according to claim 12, wherein during the process that the smoking switch is triggered, a cigarette ash light is lighted; the cigarette ash light is deposited at the end of the sleeve tube that is far away from the mouth end and is configured for the simulation of the burning of the tobacco.

14. The method for the electronic cigarette extinguishment according to claim 11, wherein the electronic cigarette entering the normal working state is achieved by triggering a smoking switch; after the smoking switch has been triggered, a cigarette ash light deposited at the end of the sleeve tube that is far away from the mouth end and is configured for the simulation of the burning of the tobacco grows darker until reaching to the end of a predetermine period of time after the smoking switch is triggered or pressing down the push-button switch to control the electronic cigarette to stop working, and then the cigarette ash light is extinguished.
